(19) United States
(12) Patent Application Publication
(10) Pub. No.: US 2012/0325374 A1
(43) Pub. Date: Dec. 27, 2012

(54) DECORATIVE COMPONENT, TIMEPIECE, AND MANUFACTURING METHOD OF DECORATIVE COMPONENT

(76) Inventors: Takuya MURAZUMI, Chiba-shi (JP); Akiko Araki, Chiba-shi (JP); Takashi Niwa, Chiba-shi (JP); Matsuo Kishi, Chiba-shi (JP)

(21) Appl. No.: 13/471,596

(22) Filed: May 15, 2012

(30) Foreign Application Priority Data
Jun. 21, 2011 (JP) 2011-137040

(51) Int. Cl. B32B 15/04; C23C 8/34

(52) U.S. Cl. 148/237; 148/317

(57) ABSTRACT

To provide a decorative component, a timepiece, and a manufacturing method of the timepiece capable of improving workability for color development and of enhancing decorativeness. A surface of an oscillating weight 160 develops a color by forming anode oxide films 22a and 22b on the surface of the oscillating weight body 164 which is formed using titanium or a titanium alloy, and on the surface of the oscillating weight body 164, of the portions at which the anode oxide films 22a and 22b are formed, a nitridization treatment layer 21 is formed at the portion at which the anode oxide film 22a is formed.

### BACKGROUND OF THE INVENTION

1. Field of the Invention

The present invention relates to a decorative component, a timepiece, and a manufacturing method of the decorative component.

2. Description of the Related Art

Generally, pure titanium (hereinafter, simply referred to as “titanium”) and titanium alloys are lightweight and have high specific strength. Furthermore, they are excellent metals from the viewpoint of corrosion resistance, and thus are used for various different applications.

For example, components used for a mechanical timepiece are required to have high impact resistance to falling or the like, high strength, high elasticity, high vibration absorption, and therefore, titanium, a titanium alloy or the like can be said to be suitable for this application. In addition, since titanium and titanium alloys have sufficient corrosion resistance, post-treatment such as anti-rust treatment is not necessary, but in a case where components are made of metals other than titanium or a titanium alloy, such as iron, anti-rust treatment is necessary.

As an anti-rust treatment, for example, plating may be considered to, but, if the plating is a thin film, there is concern that pin holes form easily and durability deteriorates. On the other hand, if the plating is a thick film, there is concern that dimension errors are increased in timepiece components with tight tolerance requirements. For this reason, components are formed using titanium or a titanium alloy, and undergo an anode oxidation treatment, and thereby it is possible to enhance decorativeness through color development without a necessity for anti-rust treatment (for example, refer to Japanese Patent Reference No. 4053127 (Patent Reference 1)).

However, in the above-described related art, the periphery of an area in which color development through the application of anode oxidation treatment is desired must be masked using a tape or a masking agent. Particularly, in a case where multiple colors are to be developed, there is a problem in that it is necessary to shift the masking position for each color which is to be developed, and thus workability is decreased.

In addition, in a case where masking is performed using a tape, there is a problem in that it is difficult to adjust an adhesion position of the tape with high accuracy and decorativeness is spoiled.

Further, in a case where reliable masking is performed using a masking agent, it is necessary to enhance adhesiveness with titanium or a titanium alloy, but, in this case, there is a problem in that the process for removing the masking agent is burdensome, and thus workability is deteriorated. In addition, there is a problem in that components are damaged when the masking agent is removed, and thereby decorativeness is spoiled.

### SUMMARY OF THE INVENTION

Therefore, the present invention has been made in consideration of the above-mentioned circumstances, and is to provide a decorative component, a timepiece, and a manufacturing method of the decorative component capable of improving workability for color development and improving decorativeness.

In order to solve the problems mentioned above, a decorative component related to the present invention includes a base material formed using titanium or a titanium alloy, wherein a surface of the base material develops a color by forming an oxide film on the surface of the base material, and wherein an inactivation treatment is performed for at least a part of the portion at which the oxide film is formed on the surface of the base material.

With this configuration, the oxidation reaction speed at the portion for which the inactivation process is performed can be made to be lower than the oxidation reaction speed at the portion for which the inactivation process is not performed. For this reason, a film thickness of the oxide film formed at the portion for which the inactivation treatment is performed is set to be smaller than a film thickness of the oxide film formed at the portion for which the inactivation treatment is not performed. As a result, the portion for which the inactivation treatment is performed and the portion for which the inactivation treatment is not performed can develop different colors.

Therefore, since a desired area can develop a desired color without performing masking using a tape or a masking agent as in the related art, it is possible to improve workability for color development of the decorative component, and to reliably enhance decorativeness as a result of preventing the decorative component from being damaged when removing the tape or the masking agent.

In the decorative component related to the present invention, the inactivation treatment may be a nitridization treatment.

With this configuration, it is possible to simply and reliably perform the inactivation treatment for the base material. For this reason, the portion for which the inactivation treatment is performed and the portion for which the inactivation treatment is not performed can develop different colors, and thus it is possible to enhance decorativeness.

A timepiece related to the present invention includes the decorative component according to claim 1 or 2.

With this configuration, it is possible to provide a timepiece capable of improving workability for color development and enhancing decorativeness.

A manufacturing method of a decorative component related to the present invention including a base material formed using titanium or a titanium alloy, wherein a surface of the base material develops a color by forming an oxide film on the surface of the base material, includes an inactivation treatment step of performing an inactivation treatment for at least a part of the surface of the base material; and an oxide film formation step of forming an oxide film at a portion for which the inactivation treatment is performed and at other portions for which the inactivation treatment is not performed on the surface of the base material.

With this method, a desired area can develop a desired color without performing masking using a tape or a masking agent. For this reason, it is possible to improve workability for color development of the decorative component, and to reliably enhance decorativeness as a result of preventing the decorative component from being damaged when removing the tape or the masking agent.

In the manufacturing method of the decorative component related to the present invention, the oxide film formed on the surface of the base material in the oxide film formation step may be an anode oxide film.

With this method, it is possible to make the decorative component develop a distinct color.

In the manufacturing method of the decorative component related to the present invention, the inactivation treatment performed on the surface of the base material in the inactivation treatment step may be a nitridization treatment.

With this method, it is possible to reliably perform the inactivation treatment for the base material and to thereby enhance decorativeness.

In the manufacturing method of the decorative component related to the present invention, the nitridization treatment may be performed by spraying a nitrogen gas onto the base material while exposing the surface of the base material to laser light.

With this method, a boundary between a portion at which the nitridization treatment is performed and a portion at which the nitridization treatment is not performed can be set with high accuracy. For this reason, it is possible to further enhance decorativeness.

According to the present invention, the oxidation reaction speed at the portion for which the inactivation process is performed can be made to be lower than the oxidation reaction speed at the portion for which the inactivation process is not performed. For this reason, a film thickness of the oxide film formed at the portion for which the inactivation treatment is performed is set to be smaller than a film thickness of the oxide film formed at the portion for which the inactivation treatment is not performed. As a result, the portion for which the inactivation treatment is performed and the portion for which the inactivation treatment is not performed can develop different colors.

Therefore, since a desired place can develop a desired color without performing masking using a tape or a masking agent as in the related art, it is possible to improve workability for color development of the decorative component, and to reliably enhance decorativeness as a result of preventing the decorative component from being damaged when removing the tape or the masking agent.

### BRIEF DESCRIPTION OF THE DRAWINGS

FIG. 1 is a plan view of a movement according to an embodiment of the present invention viewed from the top side.

FIG. 2 is a schematic configuration diagram of an automatic winding mechanism according to an embodiment of the present invention.

FIG. 3 is a plan view of an oscillating weight according to an embodiment of the present invention.

FIG. 4 is a diagram illustrating a manufacturing method of the oscillating weight according to an embodiment of the present invention.

FIG. 5 is a diagram illustrating a state of the manufacturing procedure of the oscillating weight according to an embodiment of the present invention.

FIG. 6 is a diagram illustrating a state of the manufacturing procedure of the oscillating weight according to an embodiment of the present invention.

### DETAILED DESCRIPTION OF THE PREFERRED EMBODIMENTS

### Automatic Winding Wristwatch

Next, embodiments of the present invention will be described with reference to the drawings.

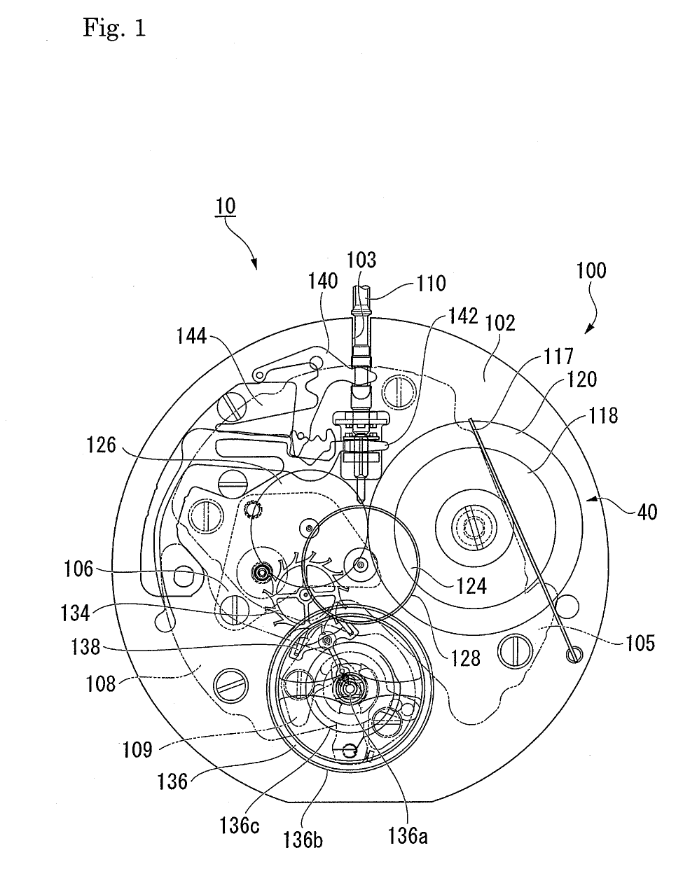

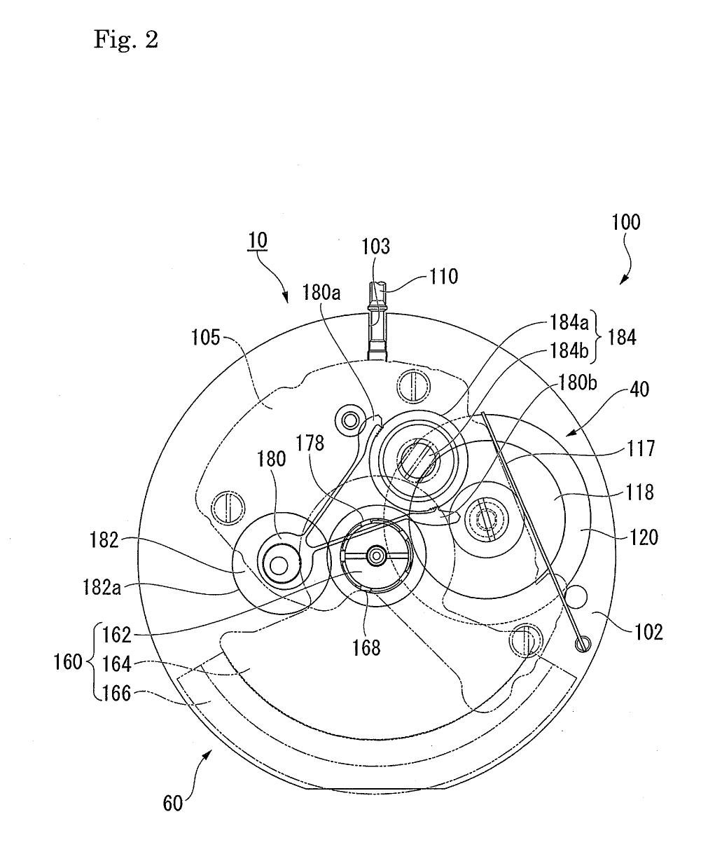

FIG. 1 is a plan view of a movement viewed from the top side in a state when an automatic winding mechanism has been removed, and FIG. 2 is a schematic configuration diagram of the automatic winding mechanism.

As shown in FIGS. 1 and 2, an automatic winding wristwatch into which a decorative component (for example, an oscillating weight 160 described later) related to the present invention is formed by a movement 100 and a casing (not shown) which accommodates the movement 100, and a dial (not shown) is attached to the movement 100. The movement 100 includes a main plate 102 forming a substrate, a barrel and train wheel bridge 105, a center wheel bridge 106, a balance bridge 108, and a pallet bridge 109. The center wheel bridge 106 is disposed between the barrel and train wheel bridge 105 and the main plate 102. The main plate 102 is provided with a hand setting stem guiding hole 103, and a hand setting stem 110 is rotatably integrated thereinto.

Here, of the sides of the main plate 102, the side where the dial is disposed (the inner side of FIGS. 1 and 2) is referred to as a back side of the movement 100, and the opposite side (the front side of FIGS. 1 and 2) to the side where the dial is disposed is referred to as a top side of the movement 100. On the back side of the movement 100, wheel trains referred to as back train wheels, and a switching device including a setting lever 140, a yoke 142, and a setting lever spring 144 are disposed. A position in the axis direction of a hand setting stem 110 is determined by the switching device.

On the other hand, wheel trains referred to as top wheel trains, an escape and speed governor 40 for controlling rotation of the top wheel trains, and an automatic winding mechanism 60 are integrated into the top side of the movement 100.

The top wheel trains are formed by a barrel 120, a second wheel & pinion 124, a third wheel & pinion 126, and a fourth wheel & pinion 128. The barrel 120 is rotatably supported by the barrel and train wheel bridge 105 and the main plate 102, and includes a mainspring (not shown). In addition, when the hand setting stem 110 is rotated, a clutch wheel (not shown) is rotated, and further the mainspring can be wound up via a winding pinion and a crown wheel (neither of which are shown) and a ratchet wheel 118.

In addition, the tooth portion of the ratchet wheel 118 comes into mesh with a plate-shaped click 117, and, thereby, rotation of the ratchet wheel 118 is set.

On the other hand, the barrel 120 is rotated by the rotation force when the mainspring is rewound, and further the second wheel & pinion 124 is configured to be rotated. The second wheel & pinion 124 is rotatably supported by the center wheel bridge 106 and the main plate 102. When the second wheel & pinion 124 is rotated, the third wheel & pinion 126 is rotated.

The third wheel & pinion 126 is rotatably supported by the barrel and train wheel bridge 105 and the main plate 102. When the third wheel & pinion 126 is rotated, the fourth wheel & pinion 128 is rotated. The fourth wheel & pinion 128 is rotatably supported by the barrel and train wheel bridge 105 and the center wheel bridge 106. The rotation of the fourth wheel & pinion 128 drives the escape and speed governor 40.

(Escape and Speed Governor)

The escape and speed governor 40 includes a balance wheel hairspring 136, an escape wheel & pinion 134, and a pallet fork 138. The pallet fork 138 is rotatably supported by the pallet bridge 109 and the main plate 102. The balance wheel hairspring 136 is rotatably supported by the balance bridge 108 and the main plate 102. The balance wheel hairspring 136 includes a balance staff 136a, a balance wheel 136b, and a hairspring 136c.

With this configuration, the escape and speed governor 40 controls the second wheel & pinion 124 so as to be changed once an hour. A cannon pinion (not shown) is configured to be simultaneously rotated based on the rotation of the second wheel & pinion 124, and a minute hand (not shown) attached to the cannon pinion indicates “minutes”.

In addition, a slip mechanism for the second wheel & pinion 124 is provided at the cannon pinion. An hour wheel & pinion (neither of which are shown) is configured to be changed once every twelve hours through a minute wheel based on the rotation of the cannon pinion. In addition, an hour hand (not shown) attached to the hour wheel & pinion indicates “hours”.

In addition, by the rotation of the second wheel & pinion 124, the fourth wheel & pinion 128 is changed once for one minute through the rotation of the third wheel & pinion 126. A second hand (not shown) is attached to the fourth wheel & pinion 128.

(Automatic Winding Mechanism)

The automatic winding mechanism 60 winds up the mainspring (not shown) of the barrel 120 by moving an oscillating weight 160 forming the automatic winding mechanism 60 with motion of the arm of a user. The oscillating weight 160 includes a ball bearing 162, an oscillating weight body 164, and a weight 166. The ball bearing 162 includes an inner wheel, an outer wheel, and a plurality of balls (none of which are shown) provided between the outer wheel and the inner wheel, and the inner wheel is fixed to the barrel and train wheel bridge 105 via a ball bearing stop screw 168.

(Oscillating Weight)

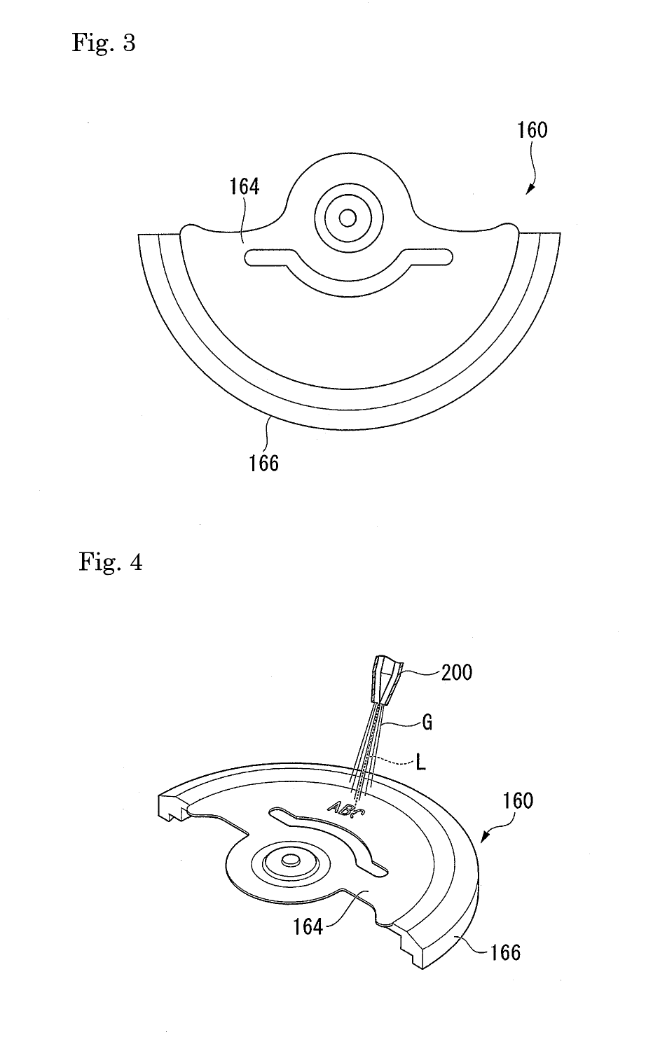

FIG. 3 is a plan view of the oscillating weight.

As shown in FIGS. 2 and 3, the oscillating weight body 164 of the oscillating weight 160 is formed substantially in a flabellate shape in plan view using either titanium (Ti) or a titanium alloy which can be treated using anode oxidation treatment. The ball bearing 162 is disposed at the rotation center of the oscillating weight body 164, and the outer wheel of the ball bearing 162 and the oscillating weight body 164 are fixed thereto.

In addition, the weight 166 is integrally formed with the outer circumferential edge of the oscillating weight body 164 so as to be curved along the outer circumferential edge. Further, the oscillating weight body 164 and the weight 166 may not be integrally formed, and the oscillating weight body 164 and the weight 166 may be fixed to each other via a fastening member.

An oscillating weight pinion 178 is provided at the outer wheel of the ball bearing 162 of the oscillating weight body 164. The oscillating weight pinion 178 comes into mesh with a first transmission wheel gear 182a of a first transmission wheel 182.

The first transmission wheel gear 182a is rotatably supported by the barrel and train wheel bridge 105 and the main plate 102. In addition, a pawl lever 180 is integrated between the first transmission wheel 182 and the barrel and train wheel bridge 105. The pawl lever 180 is attached in an eccentric form from the shaft center of the first transmission wheel 182, and includes a pulling finger 180a and a pushing finger 180b. The pulling finger 180a and the pushing finger 180b come into mesh with a second transmission wheel gear 184a of a second transmission wheel 184.

The second transmission wheel 184 includes a second transmission pinion 184b in addition to the second transmission wheel gear 184a. The second transmission wheel gear 184a is located between the oscillating weight body 164 and the barrel and train wheel bridge 105. On the other hand, the second transmission pinion 184b comes into mesh with the ratchet wheel 118.

In addition, the pulling finger 180a and the pushing finger 180b of the pawl lever 180 coming into mesh with the second transmission wheel gear 184a are biased to the center of the second transmission wheel gear 184a by an elastic force.

With this configuration, when the oscillating weight 160 is rotated, the oscillating weight pinion 178 is rotated simultaneously, and the first transmission wheel 182 is rotated by the rotation of the oscillating weight pinion 178. The pawl lever 180 attached in an eccentric form from the shaft center of the first transmission wheel 182 is reciprocated by the rotation of the first transmission wheel 182. The second transmission wheel 184 is rotated in a specific direction by the pulling finger 180a and the pushing finger 180b. Then, the ratchet wheel 118 is rotated by the rotation of the second transmission wheel 184, and the mainspring (not shown) of the barrel 120 is wound up.

Here, the back side of the casing (not shown) of the automatic winding wristwatch 10 is transparent such that the inside thereof is visible. For this reason, the surface of the oscillating weight 160, which is visible through the casing (not shown), develops a color, and designability of the automatic winding wristwatch 10 is improved. Hereinafter, a detailed color development method of the oscillating weight 160 will be described with reference to FIGS. 4 to 6.

(Color Development Method of Oscillating Weight)

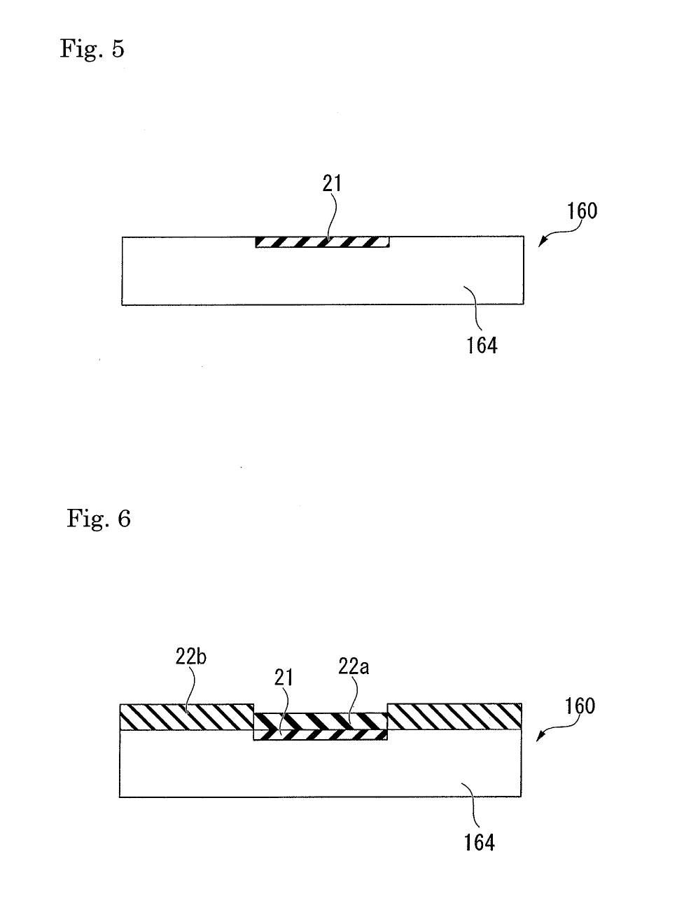

FIG. 4 is a diagram illustrating a manufacturing method of the oscillating weight 160, and FIGS. 5 and 6 are diagrams illustrating states during manufacturing processes of the oscillating weight 160.

Here, when developing a color on the surface of the oscillating weight 160, first, a desired area is inactivated (inactivation treatment step) by performing a nitridization treatment on the desired area of the oscillating weight 160. Thereafter, an anode oxidation treatment is performed on the surface of the oscillating weight 160, thereby forming an oxide film on the surface of the oscillating weight 160 (oxide film formation step).

(Inactivation Treatment Step)

The inactivation treatment step will be described in detail.

As shown in FIGS. 4 and 5, first, an outer shape of the oscillating weight 160 is formed using either titanium or a titanium alloy, and is then cleaned using a detergent to sufficiently remove oil or dirt. Thereafter, a nitrogen gas G is sprayed onto the surface of the oscillating weight 160 using a nitridization treatment device 200 while a desired area is exposed to laser light L. Then, a nitridization treatment layer 21 which has undergone the nitridization treatment is formed in the area which was exposed to the laser light L.

Here, since the nitridization treatment is performed on the surface of the oscillating weight 160 using the laser light L, as shown in FIG. 4, it is possible to form the nitridization treatment layer 21 as characters in planar view. In addition, a nitrogen purity of the nitrogen gas G sprayed onto the surface of the oscillating weight 160 is, for example, 99% or more. In addition, a film thickness of the nitridization treatment layer 21 is set to, for example, about 15 nm to 30 nm.

In addition, as the film thickness is increased, a color of the film thickness is changed from a golden color, violet, blue, pink, to green in this order. For this reason, in a case where the thickness of the nitridization treatment layer 21 is set to about 15 nm to 30 nm, the surface of the oscillating weight 160 develops a substantially golden color.

(Oxide Film Formation Step)

Next, an oxide film formation step will be described.

As shown in FIG. 6, the oscillating weight 160 is immersed into an electrolyte, connected to an anode, and conducted between it and a cathode, thereby a so-called anode oxidation treatment is performed. Thereby, water is electrolyzed to form anode oxide films 22a and 22b on the surface of the oscillating weight 160. Thereafter, the oscillating weight 160 is cleaned using pure water, and is dried using an air blower, and then the oxide film formation step is completed.

As a detailed condition of the anode oxidation treatment, for example, the following conditions may be included.

1. Electrolyte: phosphoric acid (H₃PO₄) 15 ml is dissolved to create a solution of 1000 ml

2. Treatment environment temperature: room temperature (for example, about 25° C.)

3. Conduction conditions
Voltage up speed: set to 9.75 [V/sec] and conducted for two seconds
Maintaining voltage: set to 19.5 [V/sec] and conducted for sixty seconds
Voltage Down Speed: set to 0.975 [V/sec] and conducted for twenty seconds

Here, the nitridization treatment layer 21 is formed in the desired area on the surface of the oscillating weight 160. The area in which the nitridization treatment layer 21 is formed is inactivated, and an anode oxidation reaction speed is lower than an area in which the nitridization treatment layer 21 is not formed. For this reason, the film thickness of the anode oxide film 22a formed on the surface of the nitridization treatment layer 21 is smaller than the film thickness of the anode oxide film 22b formed on the surface of the area in which the nitridization treatment layer 21 is not formed.

More specifically, for example, in a case where the film thickness of the anode oxide film 22b formed on the surface of the area in which the nitridization treatment layer 21 is not formed is about 70 nm, the film thickness of the anode oxide film 22a formed on the surface of the nitridization treatment layer 21 is about 50 nm to 60 nm.

In a case with this film thickness, the surface of the area in which the nitridization treatment layer 21 is not formed develops substantially blue, and the surface of the area in which the nitridization treatment layer 21 is formed develops substantially violet.

(Effect)

Therefore, according to the above-described embodiment, the nitridization treatment layer 21 is formed in a desired area of the oscillating weight 160, and thereby the anode oxidation reaction speed on the nitridization treatment layer 21 can be made to be lower than the anode oxidation reaction speed of the area in which the nitridization treatment layer 21 is not formed. For this reason, the film thickness of the anode oxide film 22a formed on the surface of the nitridization treatment layer 21 can be smaller than the film thickness of the anode oxide film 22b formed on the surface of the area in which the nitridization treatment layer 21 is not formed. Since the film thicknesses of the anode oxide films 22a and 22b are different from each other, colors of the anode oxide films 22a and 22b are also different from each other.

Therefore, since a desired area can develop a desired color without performing masking using a tape or a masking agent as in the related art, it is possible to improve workability for color development of the decorative component, and to reliably enhance decorativeness of the oscillating weight 160 as a result of preventing the oscillating weight 160 from being damaged when removing the tape or the masking agent.

In addition, since the oscillating weight 160 develops a color using the anode oxide films 22a and 22b, the oscillating weight 160 can develop a distinct color.

In addition, since a desired area of the oscillating weight 160 is inactivated with the nitridization treatment layer 21, it is possible to simply and reliably lower a reaction speed of the subsequent anode oxidation. For this reason, a color of the desired area of the oscillating weight 160 can be reliably different from colors of other areas.

In addition, since the nitridization treatment layer 21 is formed by exposing the oscillating weight 160 to the laser light L, a boundary between an area in which the nitridization treatment layer 21 is formed and an area in which the nitridization treatment layer 21 is not formed can be set with high accuracy. For this reason, it is possible to further enhance decorativeness of the oscillating weight 160.

In addition, the present invention is not limited to the above-described embodiment but includes various modifications of the embodiment without departing from the aim of the present invention.

For example, in the above-described embodiment, a case has been described in which, when the nitridization treatment layer 21 is formed on the oscillating weight 160, the nitrogen gas G is sprayed onto the surface of the oscillating weight 160 while a desired area is exposed to the laser light L. However, the present invention is not limited thereto, and a configuration in which the nitridization treatment is performed by an area of the oscillating weight 160 in which color development of a different color is desired is heated under a nitrogen atmosphere is also possible. In this case, as conditions of the nitridization treatment, for example, the following conditions may be included.

1. Treatment environment temperature: 950° C.

2. Treatment time: 10 hours

3. Nitrogen purity: 99% or more

Under these conditions, a thickness of the nitridization treatment layer formed at the oscillating weight 160 is 15 nm to 30 nm.

In addition, in the above-described embodiment, a case has been described in which the nitridization treatment is performed as an inactivation treatment for lowering the anode oxidation reaction speed in a desired area of the oscillating weight 160, and the nitridization treatment layer 21 is formed on the surface of the oscillating weight 160. However, the present invention is not limited thereto, and any inactivation process for lowering the anode oxidation reaction speed in a desired area of the oscillating weight 160 may be employed.

For example, a carbonization treatment may be performed instead of the nitridization treatment, and a carbonization treatment layer may be formed on the surface of the oscillating weight 160 instead of the nitridization treatment layer 21.

In addition, an anode oxide film may be formed by performing the anode oxidation treatment in a desired area of the oscillating weight 160 in advance, and, thereafter, the anode oxidation treatment may be performed for the entire oscillating weight 160, thereby forming the anode oxide film over the entire oscillating weight 160. In the case of this configuration as well, the area in which the anode oxidation treatment has been performed in advance has already undergone an oxidation reaction and is thus inactivated. That is to say, thereafter, even if the anode oxidation treatment is performed over the entire oscillating weight 160, a film thickness of the anode oxide film formed in the area in which the anode oxidation treatment has been performed in advance and a film thickness of the anode oxide film formed in an area in which the anode oxidation treatment is not performed can be made to be different from each other.

Further, in the above-described embodiment, a case has been described in which a desired area of the oscillating weight body 164 of the oscillating weight 160 develops a color different from colors developed in other areas. However, the present invention is not limited thereto, and a desired area of the weight 166 of the oscillating weight 160 may develop a different color.

Further, the present invention is applicable to a variety of components used in the automatic winding wristwatch 10. For example, in addition to the oscillating weight 160, the present invention is applicable to a variety of components such as, the main plate 102, the barrel and train wheel bridge 105, the center wheel bridge 106, the balance bridge 108, the pallet bridge 109, the respective wheels 120 to 128, the balance wheel 136b, and the like. Further, the present invention is not limited to the components constituting the automatic winding wristwatch 10, and is applicable to a variety of components which develop colors through formation of an oxide film.

What is claimed is:

1. A decorative component comprising a base material formed using titanium or a titanium alloy,
wherein a surface of the base material develops a color by forming an oxide film on the surface of the base material, and
wherein an inactivation treatment is performed for at least a part of the portion at which the oxide film is formed on the surface of the base material.

2. The decorative component according to claim 1, wherein the inactivation treatment is a nitridization treatment.

3. A timepiece comprising the decorative component according to claim 1.

4. A manufacturing method of a decorative component including a base material formed using titanium or a titanium alloy, wherein a surface of the base material develops a color by forming an oxide film on the surface of the base material, the manufacturing method comprising:
an inactivation treatment step of performing an inactivation treatment for at least a part of the surface of the base material; and
an oxide film formation step of forming an oxide film at a portion for which the inactivation treatment is performed and at other portions for which the inactivation treatment is not performed on the surface of the base material.

5. The manufacturing method of the decorative component according to claim 4, wherein the oxide film formed on the surface of the base material in the oxide film formation step is an anode oxide film.

6. The manufacturing method of the decorative component according to claim 4, wherein the inactivation treatment performed for the surface of the base material in the inactivation treatment step is a nitridization treatment.

7. The manufacturing method of the decorative component according to claim 6, wherein the nitridization treatment is performed by spraying a nitrogen gas onto the base material while exposing the surface of the base material to laser light.
